(19) United States
(12) Patent Application Publication
(10) Pub. No.: US 2014/0253279 A1
(43) Pub. Date: Sep. 11, 2014

(54) COUPLED DISCRETE INDUCTOR WITH FLUX CONCENTRATION USING HIGH PERMEABLE MATERIAL

(71) Applicant: QUALCOMM INCORPORATED, San Diego, CA (US)

(72) Inventors: James Thomas Doyle, San Diego, CA (US); Amirali Shayan Arani, San Diego, CA (US); Farsheed Mahmoudi, San Diego, CA (US)

(73) Assignee: QUALCOMM Incorporated, San Diego, CA (US)

(21) Appl. No.: 13/791,113

(22) Filed: Mar. 8, 2013

(51) Int. Cl. H01F 27/36

(52) U.S. Cl. CPC H01F 27/365
USPC 336/84 M; 336/220

(57) ABSTRACT

Some implementations provide a coupled inductor structure that includes a first discrete inductor configured to generate a magnetic field, a second discrete inductor, and a first ferromagnetic layer coupled to the first discrete inductor and the second discrete inductor. The first ferromagnetic layer is configured to concentrate the magnetic field generated by the first discrete inductor within the coupled inductor structure. In some implementations, the coupled inductor structure further includes a second ferromagnetic layer coupled to the first discrete inductor and the second discrete inductor. The second ferromagnetic layer is configured to concentrate the magnetic field generated by the first discrete inductor within the coupled inductor structure. In some implementations, the coupled inductor structure is a bifilar inductor structure. The first discrete inductor includes a first set of windings and the second discrete inductor includes a second set of windings. The first and second discrete inductors share a common core.

### BACKGROUND

1. Field

Various features relate to a coupled discrete inductor with flux concentration using high permeable material.

2. Background

Discrete coupled inductors have traditional been implemented using a ladder structure. As illustrated in FIG. 1, a ladder coupled inductor structure 102 may comprise a core 104 with a plurality of inductor windings 106a-d. However, such ladder structure 102 requires a custom core 104 and windings (e.g., coils). Relative to off-the-shelf inductors, the ladder structure 102 is relatively expensive. Additionally, when placing inductors within semiconductor devices, inductors taking up the smallest possible area are desired.

Consequently, there exists a need for an efficient but cost effective coupled inductor structure/configuration.

### SUMMARY

Various features relate to coupled discrete inductors by proximity and orientation.

A first example provides a coupled inductor structure that includes a first discrete inductor configured to generate a magnetic field, a second discrete inductor, and a first ferromagnetic layer coupled to the first discrete inductor and the second discrete inductor. The first ferromagnetic layer is configured to concentrate the magnetic field generated by the first discrete inductor within the coupled inductor structure.

According to an aspect, the coupled inductor structure further includes a second ferromagnetic layer coupled to the first discrete inductor and the second discrete inductor. The second ferromagnetic layer is configured to concentrate the magnetic field generated by the first discrete inductor within the coupled inductor structure.

According to one aspect, the first and second discrete inductors are co-planar.

According to an aspect, the first discrete inductor is above the second discrete inductor.

According to one aspect, the second discrete inductor is configured to generate a current based on the magnetic field generated by the first discrete inductor.

According to an aspect, the coupled inductor structure is a bifilar inductor structure. In some implementations, the first discrete inductor includes a first set of windings and the second discrete inductor includes a second set of windings. The first and second discrete inductors share a common core.

According to one aspect, the coupled inductor structure further includes a third discrete inductor and a fourth discrete inductor.

According to an aspect, the first discrete inductor includes a non-metallic core and/or non-magnetic core.

According to one aspect, the coupled inductor structure is integrated on a surface of a package substrate. In some implementations, the package substrate is a substrate in a package on package (PoP) configuration.

According to an aspect, the coupled inductor structure is integrated inside a package substrate.

According to one aspect, the coupled inductor structure is incorporated into at least one of a music player, a video player, an entertainment unit, a navigation device, a communications device, a mobile device, a mobile phone, a smartphone, a personal digital assistant, a fixed location terminal, a tablet computer, and/or a laptop computer.

A second example provides an apparatus that includes a first inductive means for generating a magnetic field, a second inductive means, and a first shielding means coupled to the first inductive means and the second inductive means. The first shielding means is for concentrating the magnetic field generated by the first inductive means within the apparatus.

According to an aspect, the apparatus further includes a second shielding means coupled to the first inductive means and the second inductive means. The second shielding means is for concentrating the magnetic field generated by the first inductive means within the apparatus.

According to one aspect, the first and second inductive means are co-planar.

According to an aspect, the first inductive means is above the second inductive means.

According to one aspect, the second inductive means is configured to generate a current based on the magnetic field generated by the first inductive means.

According to an aspect, the apparatus is a bifilar inductor structure. In some implementations, the first inductive means includes a first set of windings, the second inductive means a second set of windings, the first and second inductive means sharing a common core.

According to one aspect, the apparatus further includes a third inductive means and a fourth inductive means.

According to an aspect, the first inductive means includes a non-metallic core and/or non-magnetic core.

According to one aspect, the apparatus is integrated on a surface of a package substrate.

According to an aspect, the package substrate is a substrate in a package on package (PoP) configuration. According to an aspect, the apparatus is integrated inside a package substrate.

According to one aspect, the apparatus is incorporated into at least one of a music player, a video player, an entertainment unit, a navigation device, a communications device, a mobile device, a mobile phone, a smartphone, a personal digital assistant, a fixed location terminal, a tablet computer, and/or a laptop computer.

A third example provides a method for providing a coupled inductor structure. The method provides a first discrete inductor configured to generate a magnetic field. The method provides a second discrete inductor. The method provides a first ferromagnetic layer coupled to the first discrete inductor and the second discrete inductor. The first ferromagnetic layer is configured to concentrate the magnetic field generated by the first discrete inductor within the coupled inductor structure.

According to an aspect, the method also provides a second ferromagnetic layer coupled to the first discrete inductor and the second discrete inductor. The second ferromagnetic layer is configured to concentrate the magnetic field generated by the first discrete inductor within the coupled inductor structure.

According to one aspect, the first and second discrete inductors are co-planar.

According to an aspect, the first discrete inductor is provided above the second discrete inductor.

According to one aspect, the second discrete inductor is configured to generate a current based on the magnetic field generated by the first discrete inductor.

According to an aspect, the coupled inductor structure is a bifilar inductor structure. In some implementations, the first discrete inductor includes a first set of windings, and the second discrete inductor includes a second set of windings. The first and second discrete inductors share a common core.

According to one aspect, the method further provides a third discrete inductor and a fourth discrete inductor.

According to an aspect, the first discrete inductor includes a non-metallic core and/or non-magnetic core.

According to one aspect, the method further integrates the coupled inductor structure on a surface of a package substrate. In some implementations, the package substrate is a substrate in a package on package (PoP) configuration.

According to an aspect, the method further integrates the coupled inductor structure inside a package substrate.

According to one aspect, the method further incorporates the coupled inductor structure into at least one of a music player, a video player, an entertainment unit, a navigation device, a communications device, a mobile device, a mobile phone, a smartphone, a personal digital assistant, a fixed location terminal, a tablet computer, and/or a laptop computer.

### DRAWINGS

Various features, nature and advantages may become apparent from the detailed description set forth below when taken in conjunction with the drawings in which like reference characters identify correspondingly throughout.

FIG. 1 illustrates a ladder structure inductor.

FIG. 2 illustrates a discrete inductor.

FIG. 3 illustrates a coupled inductor structure with two discrete inductors.

FIG. 4 illustrates a coupled inductor structure with two discrete inductors and ferromagnetic layers.

FIG. 5 illustrates a coupled inductor structure with four discrete inductors.

FIG. 6 illustrates a coupled inductor structure with four discrete inductors and ferromagnetic layers.

FIG. 7 illustrates a coupled bifilar inductor structure.

FIG. 8 illustrates a coupled bifilar inductor structure with ferromagnetic layers.

FIG. 9 illustrates a coupled inductor structure integrated in a package on package (PoP).

FIG. 10 illustrates a coupled inductor structure integrated on a package substrate.

FIG. 11 illustrates a coupled inductor structure integrated in a package substrate.

FIG. 12 illustrates a coupled inductor structure integrated in another package substrate.

FIG. 13 illustrates a flow diagram for providing a coupled inductor structure.

FIG. 14 illustrates various electronic devices that may be integrated with any of the aforementioned integrated circuit, die, die package and/or substrate.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

### Overview

Some novel features pertain to a coupled inductor structure that includes a first discrete inductor configured to generate a magnetic field, a second discrete inductor, and a first ferromagnetic layer coupled to the first discrete inductor and the second discrete inductor. The first ferromagnetic layer is configured to concentrate the magnetic field generated by the first discrete inductor within the coupled inductor structure. In some implementations, the coupled inductor structure further includes a second ferromagnetic layer coupled to the first discrete inductor and the second discrete inductor. The second ferromagnetic layer is configured to concentrate the magnetic field generated by the first discrete inductor within the coupled inductor structure. In some implementations, the coupled inductor structure is a bifilar inductor structure. The first discrete inductor includes a first set of windings and the second discrete inductor includes a second set of windings. The first and second discrete inductors share a common core.

### Exemplary Coupled Inductor Structure

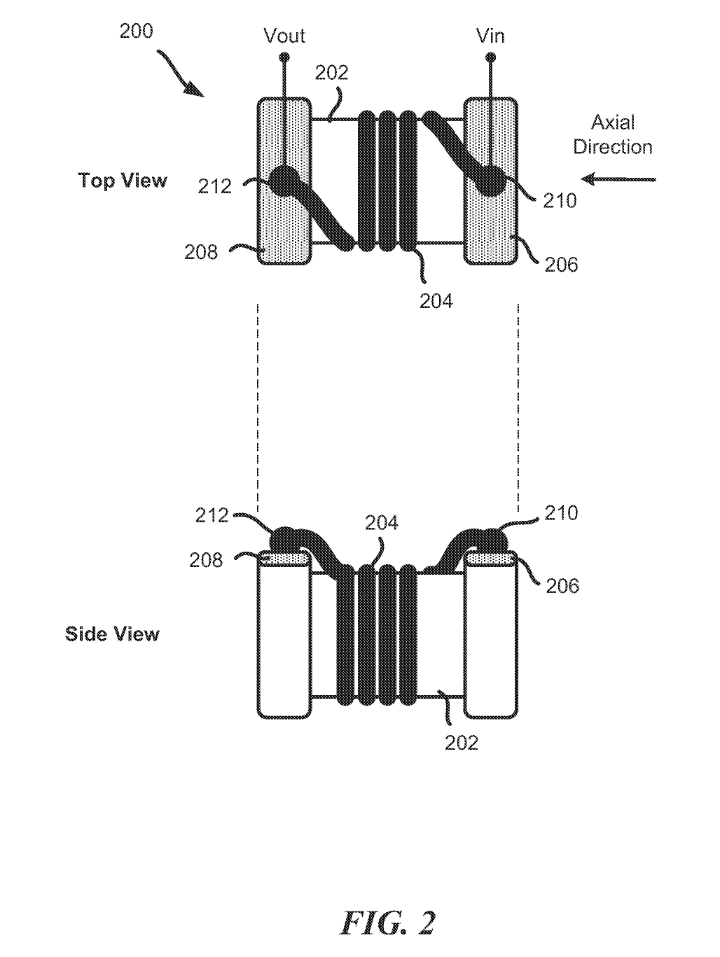

A coupled inductor structured may be defined by two or more inductors. FIG. 2 illustrates an example of inductors that may be used to define a coupled inductor structure in some implementations. In some implementations, several inductors from FIG. 2 may be used to define a coupled inductor structure.

As shown in FIG. 2, the discrete inductor 200 includes a core 202, a set of windings 204, a first metal layer 206, a second metal 208, a first terminal 210, and a second terminal 212. The core 202 may be made of a non-magnetic or non-metallic material (e.g., ceramic, silicon core). The set of windings 204 coils around the core 202. The direction of the set of windings 204 around the core 202 may be clockwise or counterclockwise.

The first terminal 210 is a first end portion of the set of windings 204. The first terminal 210 is coupled to the first metal layer 206. In some implementations, the first terminal 210 (e.g., pin) is an input terminal for an input signal. The second terminal 212 is a second end portion of the set of windings 204. The second terminal 212 is coupled to the second metal layer 208. In some implementations, the second terminal 212 (e.g., pin) is an output terminal for an output signal (e.g., ground signal). In some implementations, current may flow from the first terminal 210 to the second terminal 212. In such instances, the axial direction of the inductor 200 is the same direction as the direction of the current that flows through the inductor 200. In some implementations, when a current flows through the inductor 200, a magnetic field may be generated by the inductor 200.

In some implementations, as mentioned above, several discrete inductors (e.g., inductor 200) may be coupled together to form/define a coupled inductor structure. Such a coupled inductor structure will be further described below.

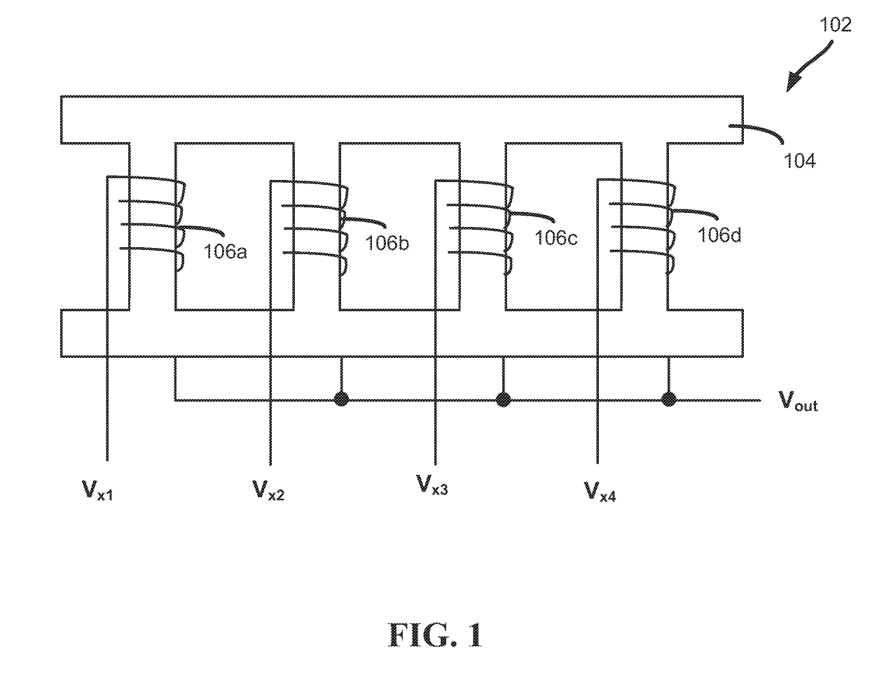

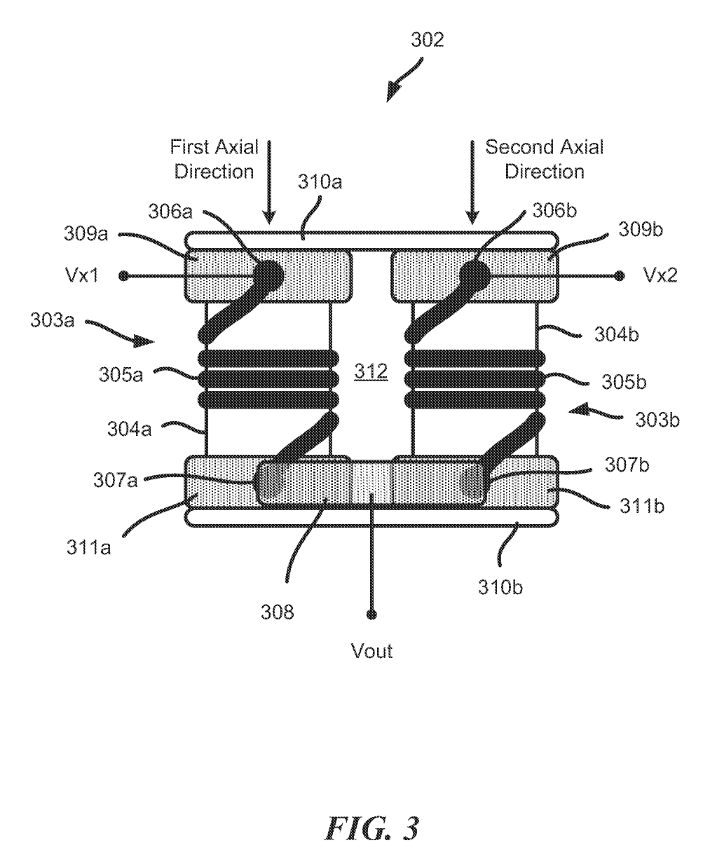

FIG. 3 illustrates an example of a coupled inductor structure that includes two discrete inductors. In some implementations, the coupled inductor structure is designed/arranged in such a way as to occupy a small effective footprint/real estate with better and/or improved coupling than the ladder structure shown and described in FIG. 1.

As shown in FIG. 3, the coupled inductor structure 302 includes a first inductor 303a, a second inductor 303b, a first ferromagnetic layer 310a, a second ferromagnetic layer 310b, and a filler 312. In some implementations, each of the inductors 303a-b is a discrete inductor (e.g., inductor 200). Each inductor 303a-b includes a core. Specifically, the first inductor 303a includes a first core 304a and the second inductor 303b includes a second core 304b. Different implementations may use different cores. In some implementations the core may be air, ceramic, silicon cores (e.g., non-magnetic or non-metallic cores).

Each inductor 303a-b includes a set of windings. Specifically, the first inductor 303a includes a first set of windings 305a (e.g. first set of coils) and the second inductor 303b includes a second set of windings 305b. Each of the set of windings 305a-b surrounds a respective core of an inductor.

Each inductor 303a-b also includes a set of pins/terminals (e.g. an input terminal and an output terminal). Specifically, the first inductor 303a includes a first input terminal 306a (e.g., Vₓ₁) and a first output terminal 307a, and the second inductor 303b includes a second input terminal 306b (e.g., Vₓ₂) and a second output terminal 307b. Each inductor 303a-b also includes a set of metal layers. Specifically, the first inductor 303a includes a first metal layer 309a and a second metal layer 311a, and the second inductor 303b includes a third metal layer 309b and a fourth metal layer 311b. In some implementations, the first input terminal 306a is coupled to the first metal layer 309a, and the first output terminal 307a is coupled to the second metal layer 311a. In some implementations, the second input terminal 306b is coupled to the third metal layer 309b, and the second output terminal 307b is coupled to the fourth metal layer 311b.

As shown in FIG. 3, the first and second output terminals 307a-b are electrically coupled to each other (e.g., in series) through a connection component 308. The connection component 308 of the coupled inductor structure 302 may be a metal material (e.g., copper) in some implementations. In some implementations, the connection component 308 may collectively represent the output terminals 307a-b. Consequently, in some implementations, the connection component 308 may represent the output terminal (e.g., Vₒᵤₜ) for the coupled inductor structure 302. In some implementations, the first and second output terminals 307a-b are electrically coupled to each other through the connection component 308 and the second and fourth metal layers 311a-b. Thus, in some implementations, the connection component 308 is coupled to the second and fourth metal layers 311a-b, which are each respectively coupled to the first and second output terminals 307a-b.

In some implementations, it is desirable to reduce/minimize hysteretic losses and eddy current losses due to adjacent foreign conductors. In some implementations, it is also desirable to provide magnetic alignment of domains in the coupled inductor structure. In some implementations, magnetic alignment focuses and concentrates magnetic field flux in the coupled inductor structure which further reduces losses (e.g., hysteretic, eddy current) and thus improves the coupling of the coupled inductor structure. One way of reducing/minimizing hysteretic losses, eddy current losses, and providing magnetic alignment is to provide a high permeability material/metal around the coupled inductor structure. Such a high permeability material reduces the spreading of the magnetic field, which effectively increases the inductance of the coupled inductor structure as well as minimizes interference (e.g., magnetic field interference) from adjacent electronics.

As shown in FIG. 3, the coupled inductor structure 302 includes a first ferromagnetic layer 310a and a second ferromagnetic layer 310b. The first ferromagnetic layer 310a may be located at a first end of the coupled inductor structure 302. The second ferromagnetic layer 310b may be located at a second end of the coupled inductor structure 302. The second end of the coupled inductor structure may be located on an opposite end of the first end of the coupled inductor structure 302. The first and second ferromagnetic layers 310a-b may not be electrically coupled to the inductors 303a-d.

In some implementations, the first and second ferromagnetic layers 310a-b may be configured to reduce losses due to metal proximity (Faraday Cage). The first and second ferromagnetic layers 310a-b may also provide shielding of the inductors 303a-d, which helps increase the effective inductance, the Q factor and/or effectiveness of the coupling of the coupled inductor structure 302 in some implementations. The effectiveness of an inductor or coupled inductor may be defined by its Q factor. A Q factor is a quality factor/value that defines the efficiency of an inductor or coupled inductor. The higher the Q factor, the closer the inductor approaches the behavior of an ideal inductor, which is a lossless inductor. Thus, generally speaking, a higher Q factor is more desirable than a lower Q factor. In some implementations, the use of the first and second ferromagnetic layers 310a-b helps increase the Q factor (e.g., increase effective inductance) of the coupled inductor structure 302 and provides magnetic shielding. In some implementations, the magnetic shielding keeps the magnetic field generated by one or more of the inductors 303a-d within the coupled inductor structure, which increases the effective impedance (e.g., increase Q factor) of the coupled inductor structure. In addition, the ferromagnetic layers 310a-b may also reduce/minimize interference from outside electronics.

The first and second ferromagnetic layers 310a-b may have high permeability (μ) and/or high B saturation. In some implementations, the permeability of a material refers to the degree of magnetization that the material obtains in response to an applied magnetic field. In some implementations, the B saturation of a material refers to the state that the material reaches when an increase in magnetic field no longer increases the magnetization of the material. An example of a ferromagnetic material could be silicon steel, Manganese-zinc ferrite (MnZn), and/or permalloy. In some implementations, the first and second ferromagnetic layers 310a-b are magnetic foils.

Each inductor 303a-d also includes an axial direction. As shown in FIG. 3, the first inductor 303a has a first axial direction that is the same as the second axial direction of the second inductor 303b. In some implementations, the axial direction of an inductor is the axial direction of a current flowing in the inductor (e.g., direction from an input terminal to an output terminal). In some implementations, an axial direction for coupling is defined by the right hand rule which establishes the direction of the magnetic field flux relative to a current direction. In some implementations, mutual coupling requires additive magnetic field flux which is usually defined by the input terminal In some implementations, magnetic reluctance and magnetic field flux can be additive or subtractive depending on the direction of the current and the magnetic field flux direction is set by where the thumb points using your right hand convention (where fingers going in the direction of the current).

In some implementations, the first inductor 303a may be provided/configured in the coupled inductor structure 302 to induce (e.g., generate) a current in the second inductor 303b. For example, a magnetic field may be generated by the first inductor 303a which induces a current in the second inductor 302b. In some implementations, different inductors from the coupled inductor structure may be provided with voltage/current with different phases. That is, in some implementations, one or more of the inductors from the coupled inductor structure may operate out of phase. In some implementations, a paired discrete inductors (e.g., first and second inductors 303a-203b) may be phase paired so that, for example, two adjacent inductors (e.g., first and second inductors 303a-203b) are out of phase by 180 degrees. Different implementations may use pairs of inductors that are out of phase by a different degree (e.g., out of phase by 45 degrees, 90 degrees). For example, in some implementations, a first inductor may be configured to operation at a first phase, a second inductor may be configured to operate at a second phase, a third inductor may be configured to operate at third phase, and a fourth inductor may be configured to operate at a fourth phase.

FIG. 3 also illustrates that the coupled inductor structure 302 includes a filler 312. In some implementations, the filler 312 is a material that couples the first inductor 303a to the second inductor 303b. Thus, in some implementations, the filler 312 may provide structural stability of the coupled inductor structure 302. In some implementations, the filler 312 is non-conductive epoxy material. In some implementations, the filler 312 improves the inductance/coupling of the coupled inductor structure 303 since the filler may have better magnetic properties (e.g., magnetic saturation) than air.

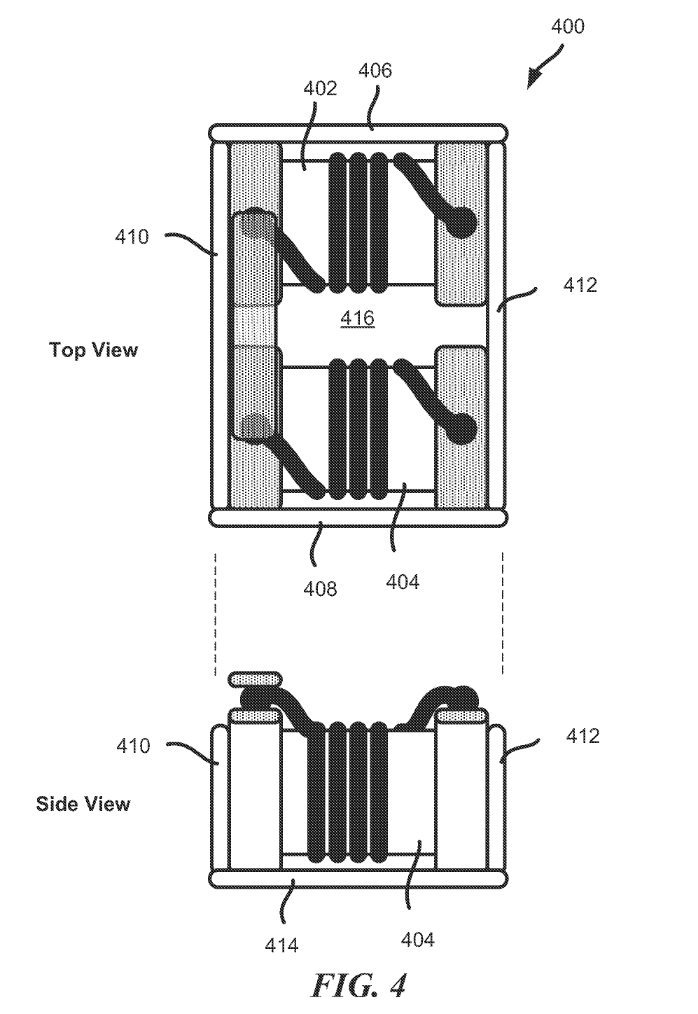

FIG. 3 illustrates a coupled inductor structure with two ferromagnetic layers. However, in some implementations, a coupled inductor structure may have more than two ferromagnetic layers. FIG. 4 illustrates an example of a coupled inductor structure that is surrounded by several ferromagnetic layers. As shown in FIG. 4, the coupled inductor structure 400 includes a first inductor 402, a second inductor 404, a first ferromagnetic layer 406, a second ferromagnetic layer 408, a third ferromagnetic layer 410, a fourth ferromagnetic layer 412, a fifth ferromagnetic layer 414, and a filler 416. In some implementations, each of the inductors 402-404 is a discrete inductor (e.g., inductor 200). The ferromagnetic layers 406-412 surround the sides of the coupled inductor structure 400 and the ferromagnetic layer 414 is located at the base of the coupled inductor structure 400.

FIGS. 3-4 illustrate the inductors (e.g., inductor 303a) in the coupled inductor structure as being co-planar to each other (e.g., side by side on same plane). However, in some implementations, one or more of the inductors may be positioned/stacked on top of another inductor in the coupled inductor structure.

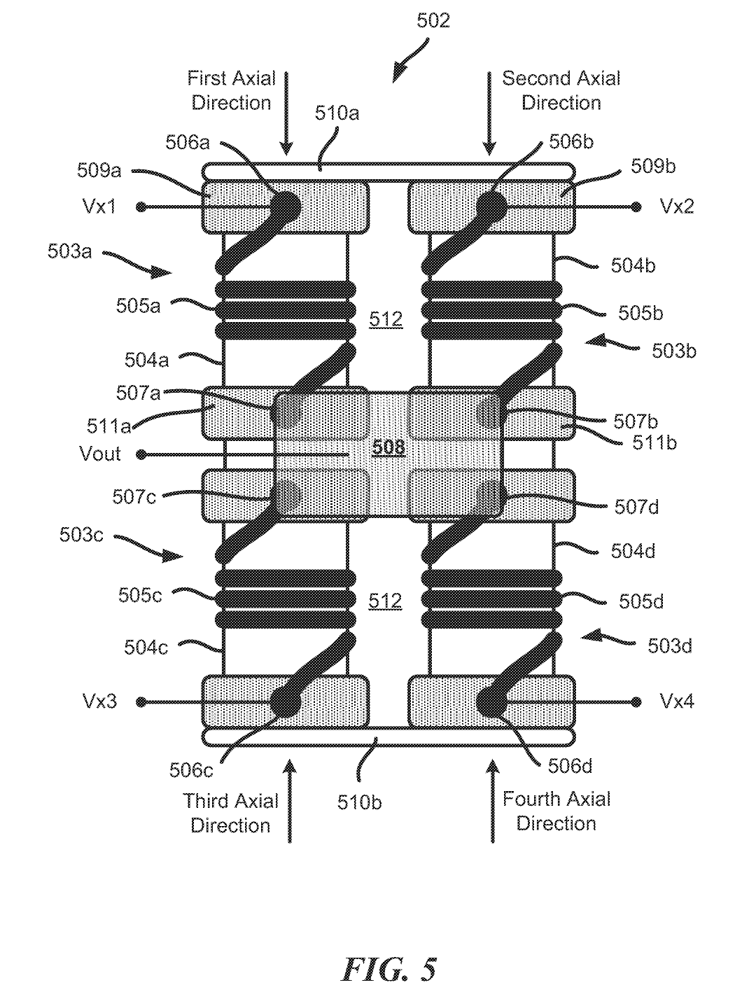

In some implementations, more than two discrete inductors may be used to form/define a coupled inductor structure. FIG. 5 illustrates an example of a coupled inductor structure that includes four discrete inductors. In some implementations, the coupled inductor structure is a coupled inductor H structure. In some implementations, the H structure is designed/arranged in such a way as to occupy a small effective footprint/real estate with better and/or improved coupling than the ladder structure shown and described in FIG. 1.

As shown in FIG. 5, the coupled inductor structure 502 includes a first inductor 503a, a second inductor 503b, a third inductor 503c, a fourth inductor 503d, a connection component 508, a first ferromagnetic layer 510a, a second ferromagnetic layer 510b, and a filler 512. In some implementations, each of the inductors 503a-d is a discrete inductor (e.g., inductor 200). Each inductor 503a-d includes a core. Specifically, the first inductor 503a includes a first core 504a, the second inductor 503b includes a second core 504b, the third inductor 503c includes a third core 504c, and the fourth inductor 503d includes a fourth core 504d. Different implementations may use different cores. In some implementations the core may be air, ceramic, silicon cores (e.g., non-magnetic or non-metallic cores).

In some implementations, each of the inductors 503a-d is a discrete inductor. Each inductor 503a-d includes a set of windings. Specifically, the first inductor 503a includes a first set of windings 505a (e.g. first set of coils), the second inductor 503b includes a second set of windings 505b (e.g. second set of coils), the third inductor 503c includes a third set of windings 505c (e.g. third set of coils), and the fourth inductor 503d includes a fourth set of windings 505d (e.g. fourth set of coils). Each of the set of windings 505a-d surrounds a respective core of an inductor.

Each inductor 503a-d also includes a set of pins/terminals (e.g. an input terminal and an output terminal). Specifically, the first inductor 503a includes a first input terminal 506a (e.g., Vₓ₁) and a first output terminal 507a, the second inductor 503b includes a second input terminal 506b (e.g., Vₓ₂) and a second output terminal 507b, the third inductor 503c includes a third input terminal 506c (e.g., Vₓ₃) and a third output terminal 507c, and the fourth inductor 503d includes a fourth input terminal 506d (e.g., Vₓ₄) and a fourth output terminal 507a.

Each inductor 503a-b also includes a set of metal layers. Specifically, the first inductor 503a includes a first metal layer 509a and a second metal layer 511a, the second inductor 503b includes a third metal layer 509b and a fourth metal layer 511b, the third inductor 503c includes a fifth metal layer 509c and a sixth metal layer 511c, and the fourth inductor 503d includes a seventh metal layer 509d and a eighth metal layer 511d. In some implementations, the first input terminal 306a is coupled to the first metal layer 309a, and the first output terminal 307a is coupled to the second metal layer 311a. In some implementations, the second input terminal 306b is coupled to the third metal layer 309b, and the second output terminal 307b is coupled to the fourth metal layer 311b In some implementations, the third input terminal 506c is coupled to the fifth metal layer 509c, and the third output terminal 507c is coupled to the sixth metal layer 511c. In some implementations, the fourth input terminal 506d is coupled to the seventh metal layer 509c, and the fourth output terminal 507d is coupled to the eighth metal layer 511d.

Each inductor 503a-d also includes an axial direction. As shown in FIG. 5, the first inductor 503a has a first axial direction that is the same as the second axial direction of the second inductor 503b. Similarly, the third inductor 503c has a third axial direction that is the same as the fourth axial direction of the fourth inductor 503d. As shown in FIG. 5, the third and fourth axial directions are opposite to the first and second axial directions.

As shown in FIG. 5, the first, second, third and fourth output terminals 507a-d are electrically coupled to each other (e.g., in series) through a connection component 508. The connection component 508 of the coupled inductor structure 502 may be a metallic material (e.g., copper) in some implementations. In some implementations, the connection component 508 may collectively represent the output terminals 507a-d. Consequently, in some implementations, the connection component 508 may represent the output terminal (e.g., Vₒᵤₜ) for the coupled inductor structure 502.

In some implementations, the first, second, third, and fourth output terminals 507a-d are electrically coupled to each other through the connection component 508 and the second, fourth, sixth and eighth metal layers 511a-d. Thus, in some implementations, the connection component 508 is coupled to the second, fourth, sixth and eighth metal layers 511a-d, which are each respectively coupled to the first, second, third and fourth output terminals 507a-d.

FIG. 5 also illustrates that the coupled inductor structure 503 includes a filler 512. In some implementations, the filler 512 is a material that couples the first, second, third and fourth inductors 503a-d together. Thus, in some implementations, the filler 512 may provide structural stability of the coupled inductor structure 502. In some implementations, the filler 512 is non-conductive epoxy material. In some implementations, the filler 512 improves the inductance/coupling of the coupled inductor structure 503 since the filler may have better magnetic properties (e.g., magnetic saturation) than air.

FIG. 5 also illustrates that the coupled inductor structure 502 includes a first ferromagnetic layer 510a and a second ferromagnetic layer 510b. The first ferromagnetic layer 510a may be located at a first end of the coupled inductor structure 502. The second ferromagnetic layer 510b may be located at a second end of the coupled inductor structure 502. The second end of the coupled inductor structure may be located on an opposite end of the first end of the coupled inductor structure 502. The first and second ferromagnetic layers 510a-b may not be electrically coupled to the inductors 503a-d. The first and second ferromagnetic layers 510a-b may be configured to reduce losses due to metal proximity (Faraday Cage). The first and second ferromagnetic layers 510a-b may also provide shielding of the inductors 503a-d, which helps increase the effective inductance, the Q factor and/or effectiveness of the coupling of the coupled inductor structure 502 in some implementations. As described above, the effectiveness of an inductor may be defined by its Q factor. A Q factor is a quality factor/value that defines the efficiency of an inductor. The higher the Q factor, the closer the inductor approaches the behavior of an ideal inductor, which is a lossless inductor. Thus, generally speaking, a higher Q factor is more desirable than a lower Q factor. In some implementations, the use of the first and second ferromagnetic layers 510a-b help increase the Q factor (e.g., increase effective inductance) of the coupled inductor structure 502 and provide magnetic shielding. In some implementations, the magnetic shielding keeps the magnetic field generated by one or more of the inductors 503a-d within the coupled inductor structure, which increases the effective impedance (e.g., increase Q factor) of the coupled inductor structure.

The first and second ferromagnetic layers 510a-b may have high permeability (μ) and/or high B saturation. In some implementations, the permeability of a material refers to the degree of magnetization that the material obtains in response to an applied magnetic field. In some implementations, the B saturation of a material refers to the state that the material reaches when an increase in magnetic field no longer increases the magnetization of the material. An example of a ferromagnetic material could be silicon steel, Manganese-zinc ferrite (MnZn), and/or permalloy. In some implementations, the first and second ferromagnetic layers 510a-b are magnetic foils.

As further shown in FIG. 5, the inductors 503a-d are arranged into pairs of inductors. Specifically, the inductors 503a-d are arranged into a first pair of inductors and a second pair of inductors. The first pair of inductors may be defined by the first inductor 503a and the second inductor 503b. The second pair of inductors may be defined by the third inductor 503c and the fourth inductor 503d. In some implementations, the inductors 503a-d are arranged in the coupled inductors structure 502 such that the first pair of inductors (e.g., inductors 503a-b) and the second pair of inductors (e.g., inductors 503c-d) are coaxially arranged with a common connection 506 in between the first pair of inductors and the second pair of inductors.

In one example, a first discrete inductor 503a may serve to induce a current in a second discrete inductor 503b and a third discrete inductor 503c may induce a current in a fourth discrete inductor 503d. The discrete inductors may have an air, ceramic, silicon cores (e.g., non-magnetic or non-metallic cores).

In some implementations, different inductors from the coupled inductor structure may be provided with voltage/current with different phases. That is, in some implementations, one or more of the inductors from the coupled inductor structure may operate out of phase. In some implementations, a paired discrete inductors (e.g., first and second inductors 503a-203b) may be phase paired so that, for example, two adjacent inductors (e.g., first and second inductors 503a-203b) are out of phase by 180 degrees. Different implementations may use pairs of inductors that are out of phase by a different degree (e.g., out of phase by 45 degrees, 90 degrees). For example, in some implementations, a first inductor may be configured to operation at a first phase, a second inductor may be configured to operate at a second phase, a third inductor may be configured to operate at third phase, and a fourth inductor may be configured to operate at a fourth phase. Additionally, while FIG. 5 illustrates the use of four inductors, some implementations may utilize eight discrete inductors (e.g. two of the H structures 502 of FIG. 5) to provide more current phases.

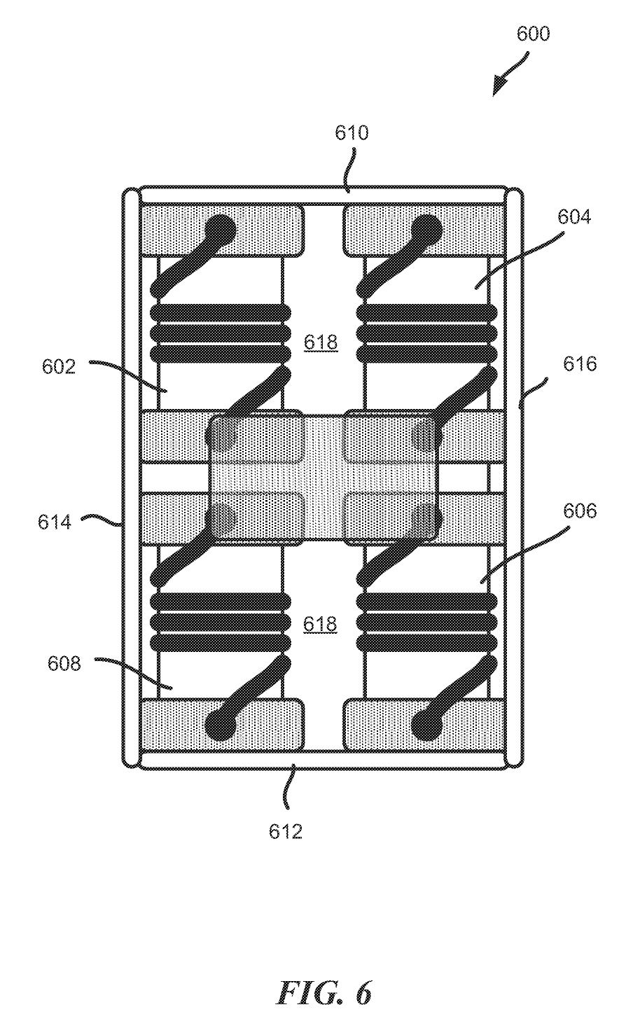

FIG. 5 illustrates a coupled inductor structure with two ferromagnetic layers. However, in some implementations, a coupled inductor structure may have more than two ferromagnetic layers. FIG. 6 illustrates an example of a coupled inductor structure that is surrounded by several ferromagnetic layers. As shown in FIG. 6, the coupled inductor structure 600 includes a first inductor 602, a second inductor 604, a third inductor 606, a fourth inductor 608, a first ferromagnetic layer 610, a second ferromagnetic layer 612, a third ferromagnetic layer 614, a fourth ferromagnetic layer 616, and a filler 618. In some implementations, each of the inductors 602-608 is a discrete inductor (e.g., inductor 200). The ferromagnetic layers 606-616 surround the sides of the coupled inductor structure 600. In some implementations, the coupled inductor structure 600 also includes a fifth ferromagnetic layer (not shown) that is located at the base of the coupled inductor structure 600.

FIGS. 3-6 illustrate the inductors (e.g., inductor 200) in the coupled inductor structure as being co-planar to each other (e.g., side by side on same plane). However, in some implementations, one or more of the inductors may be positioned/stacked on top of another inductor in the coupled inductor structure.

### Exemplary Coupled Bifilar Inductor Structure

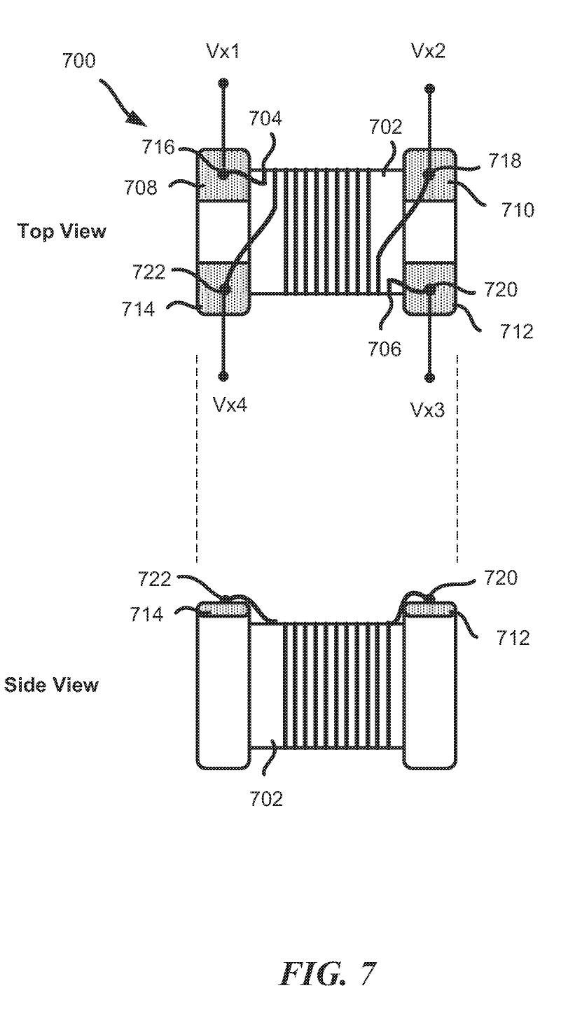

FIG. 7 illustrates a discrete coupled inductor/structure. Specifically, FIG. 7 illustrates a discrete bifilar inductor. As shown in FIG. 7, the discrete coupled bifilar inductor structure 700 includes a core 702, a first set of windings 704, a second set of windings 706, a first metal layer 708, a second metal 710, a third metal layer 712, a fourth metal layer 714, a first terminal 716, a second terminal 718, a third terminal 720 and fourth terminal 722. The core 702 may be made of a non-magnetic or non-metallic material (e.g., ceramic, silicon core). The first set of windings 704 coils around the core 702. The direction of the first set of windings 704 around the core 702 may be clockwise or counterclockwise. The second set of windings 706 coils around the core 702. The direction of the second set of windings 706 around the core 702 may be clockwise or counterclockwise. In some implementations, the directions of the first and second set of windings 704-706 are the same.

The first terminal 716 is a first end portion of the first set of windings 704. The first terminal 716 is coupled to the first metal layer 708. In some implementations, the first terminal 716 (e.g., pin) is an input terminal for an input signal. The second terminal 718 is a second end portion of the first set of windings 704. The second terminal 718 is coupled to the second metal layer 710. In some implementations, the second terminal 718 (e.g., pin) is an output terminal for an output signal (e.g., ground signal). In some implementations, current may flow from the first terminal 716 to the second terminal 718. In such instances, the axial direction of the coupled inductor structure 700 is the same direction as the direction of the current that flows through the coupled inductor structure 700. In some implementations, the first set of windings 704 is configured to provide a first inductive means (e.g., first inductor) in the coupled inductor structure 700. In some implementations, when a current flow through the first set of windings 704, a magnetic field may be generated by the first set of windings 704.

The third terminal 720 is a first end portion of the second set of windings 706. The third terminal 720 is coupled to the third metal layer 720. In some implementations, the third terminal 720 (e.g., pin) is an output terminal for an output signal (e.g., ground signal). The fourth terminal 722 is a second end portion of the second set of windings 706. The fourth terminal 722 is coupled to the fourth metal layer 714. In some implementations, the fourth terminal 722 (e.g., pin) is an input terminal for an input signal. In some implementations, current may flow from the fourth terminal 722 to the third terminal 720. In such instances, the axial direction of the coupled inductor structure 700 may be the same direction as the direction of the current that flows through the coupled inductor structure 700. In some implementations, the second set of windings 706 is configured to provide a second inductive means (e.g., second inductor) in the coupled inductor structure 700. In some implementations, a magnetic field generated by the first set of windings 704 may induce (e.g., generate) a current in the second set of windings 706.

In some implementations, the coupled bifilar inductor structure 700 may include one or more ferromagnetic layers. These one or more of these ferromagnetic layers may enhance/improve the inductance of the coupled inductor structure 700. As described above, one or more ferromagnetic layers may reduce/minimize hysteretic losses, eddy current losses, and provide magnetic alignment in the coupled bifilar inductor structure, which may enhance/improve the impedance of the coupled bifilar inductor structure. For example, the ferromagnetic layers (which may have a high permeability) may reduce the spreading of the magnetic field, which effectively increases the inductance of the coupled inductor structure as well as minimizes interference (e.g., magnetic field interference) from adjacent electronics.

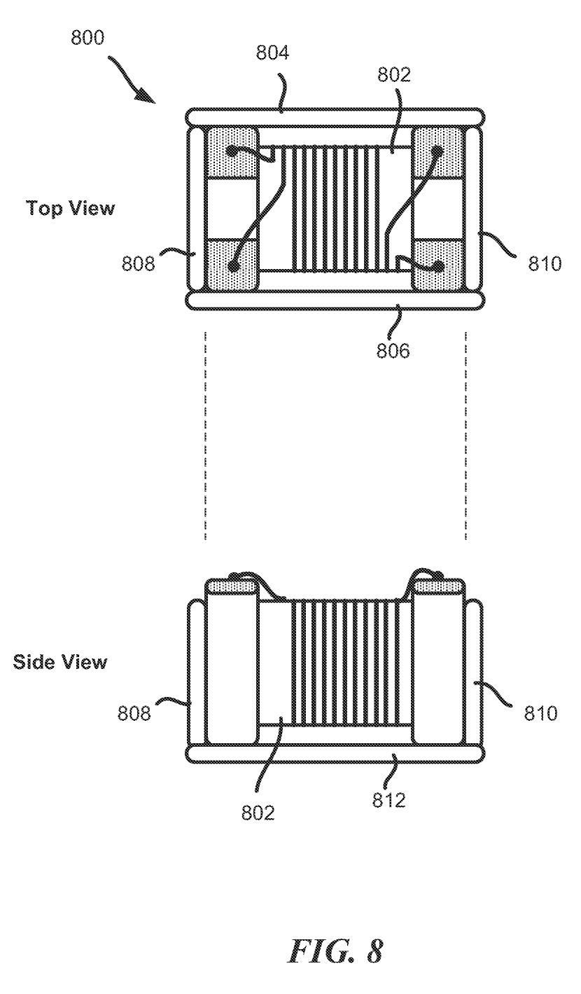

FIG. 8 illustrates an example of a coupled bifilar inductor structure that is surrounded by several ferromagnetic layers. As shown in FIG. 8, the coupled inductor structure 800 includes a coupled bifilar inductor 802, a first ferromagnetic layer 804, a second ferromagnetic layer 806, a third ferromagnetic layer 808, a fourth ferromagnetic layer 810, and a fifth ferromagnetic layer 812. The ferromagnetic layers 804-810 surround the sides of the coupled bifilar inductor structure 802 and the ferromagnetic layer 812 is located at the base of the coupled bifilar inductor structure 802.

In some implementations, several coupled bifilar inductor structures may be combined in series or in parallel. Moreover, in some implementations, one or more ferromagnetic layers may surround the several coupled bifilar inductor structures.

Having described various coupled inductor structures, several possible locations for the coupled inductor structures will now be described below.

### Exemplary Coupled Inductor Structure on Package-on-Package (PoP)

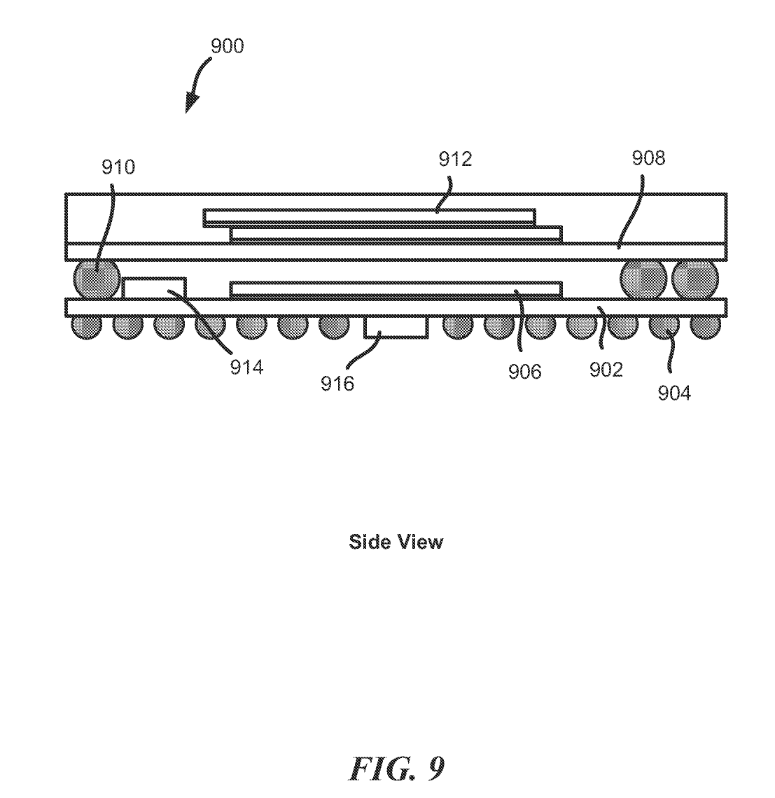

In some implementations, one or more of the coupled inductor structures (e.g., inductor structures 302, 502, 600, 700, 800) may be coupled on a substrate within a package-on-package (PoP) structure. FIG. 9 illustrates a side view of a package-on-package (PoP) structure 900 that includes coupled inductor structures. As illustrated in FIG. 9, the PoP structure includes a first package substrate 902, a first set of solder balls 904, a first die 906, a second package substrate 908, a second set of solder balls 910, a second set of dice 912, a first inductor structure 914, and a second inductor structure 916. In some implementations, the first and second inductor structures 914-616 may be one of the inductor structures 302, 502, 600, 700, 800 described above. The first die 906 may be a logic die. The second set of dice 916 may be stacked memory dice in some implementations.

The first package of the PoP structure 900 may includes the first package substrate 902, the first set of solder balls 904 and the first die 906. The first package of the PoP structure 900 may also include the first and second inductor structures 914-916. The first die 906 may be an Application Specific Integrated Circuit (ASIC) die in some implementations. The first inductor structure 914 may be integrated on the top surface of the first package substrate 902. As shown in FIG. 9, one or more solder balls may be removed to place the first inductor structure 914 on the top surface of the first package substrate 902.

An inductor structure (e.g., inductor structures 302, 502, 600, 700, 800) may also be located on the bottom surface of a package substrate. As further shown in FIG. 9, the second inductor structure 916 is located on the bottom surface of the first package substrate 902. One or more of the first set of solder balls 910 may be removed to allow the second inductor structure 916 to be placed on the bottom of the first package substrate 902. In some implementations, the first and second inductor structures 914-916 may be provided on a package substrate using landside mounting.

### Exemplary Coupled Inductors on a Package Substrate

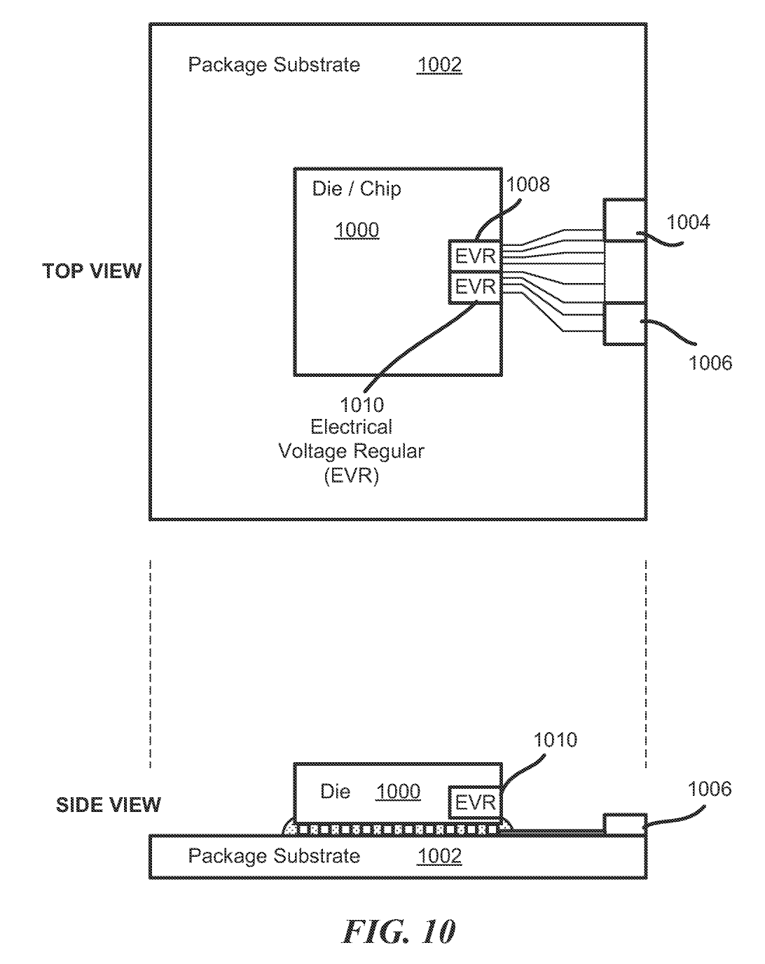

In some implementations, one or more of the inductor structures (e.g., inductor structures 302, 502, 600, 700, 800) may be coupled on a substrate within a semiconductor package. As illustrated in FIG. 10, a die/chip 1000 may be mounted on a package substrate 1002. FIG. 10 also illustrates two H structures on the surface of the package substrate 1002. Specifically, FIG. 10 illustrates a first structure 1004 and a second structure 1006 on the package substrate 1002. The first and second structures 1004-1006 are coupled to the die 1000 through a set of wiring (e.g., traces). In some implementations, the first and second structures 1004-1006 may each be the coupled inductor structure 202 shown and described in FIG. 2.

In some implementations, one or more of the inductors from the coupled inductor structure 1004-1006 may operate on different voltages. In some implementations, one or more electrical voltage regulators (EVRs) 1008-1010 may be used to regulate the voltage/current that is provided (e.g., supplied) to one or more of the inductors in the coupled inductor structures 1004-1006. In one example, a first EVR 1008 may be used to regulate and/or provide a voltage/current to the first structure 1004. The first EVR 1008 may also regulate the phase of the voltage/current that is provided to one or more inductors of the first structure 1004. Similarly a second EVR 1010 may be used to regulate and/or a voltage to the second structure 1006. The second EVR 1010 may also regulate the phase of the voltage/current that is provided to one or more inductors of the first structure 1006. As shown in FIG. 10, the first and second EVRs 1008-1010 are located on the die 1000. However, in some implementations, the EVRs 1008-1010 may be coupled to the die 1000 but physically separate from the die 1000. As further shown in FIG. 10, in some implementations, the combined dimensions of the first and second EVRs 1008-1010 may be 2 mm×2 mm or less. However, different implementations may have EVRs 1008-1010 with different dimensions.

In some implementations, the spacing between the die 1000 and one or both of the structures 1004-1006 is 2 mm or less. The spacing may be defined as the edge to edge distance between two components (e.g., distance between the edge of a die and the edge of structure). In some implementations, the spacing between the die 1000 and the outer edge of the structure (e.g., structure 1004) is greater than 10 mm and lesser than 5 mm. However, different implementations may have different spacing between the die 1000 and one or more of the structures 1004-1006. In some implementations, the structures 1004-1006 may be provided on a package substrate using landside mounting.

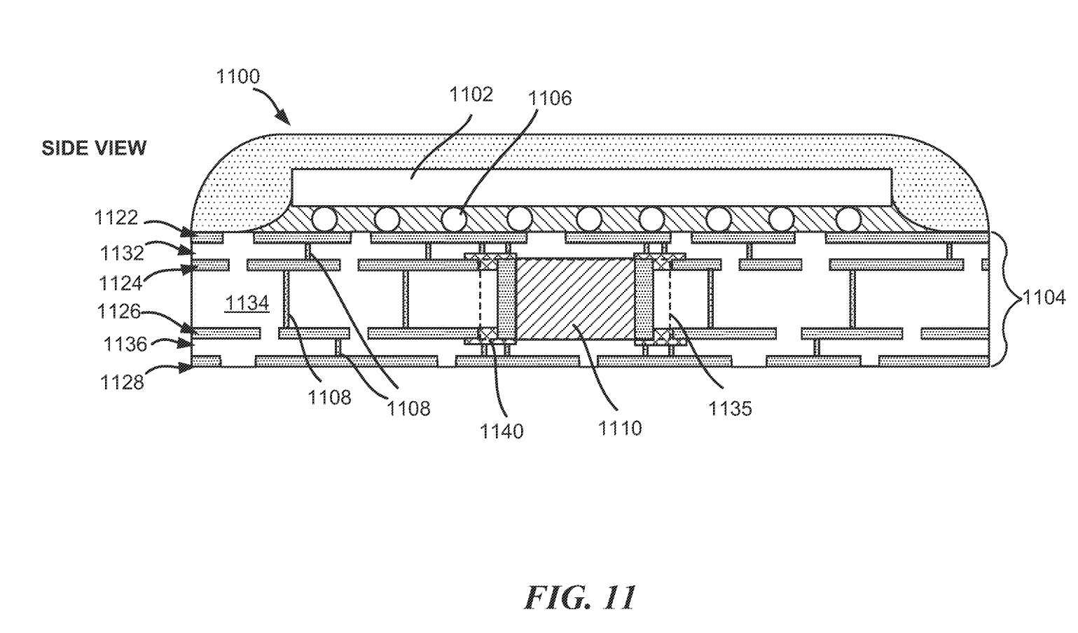

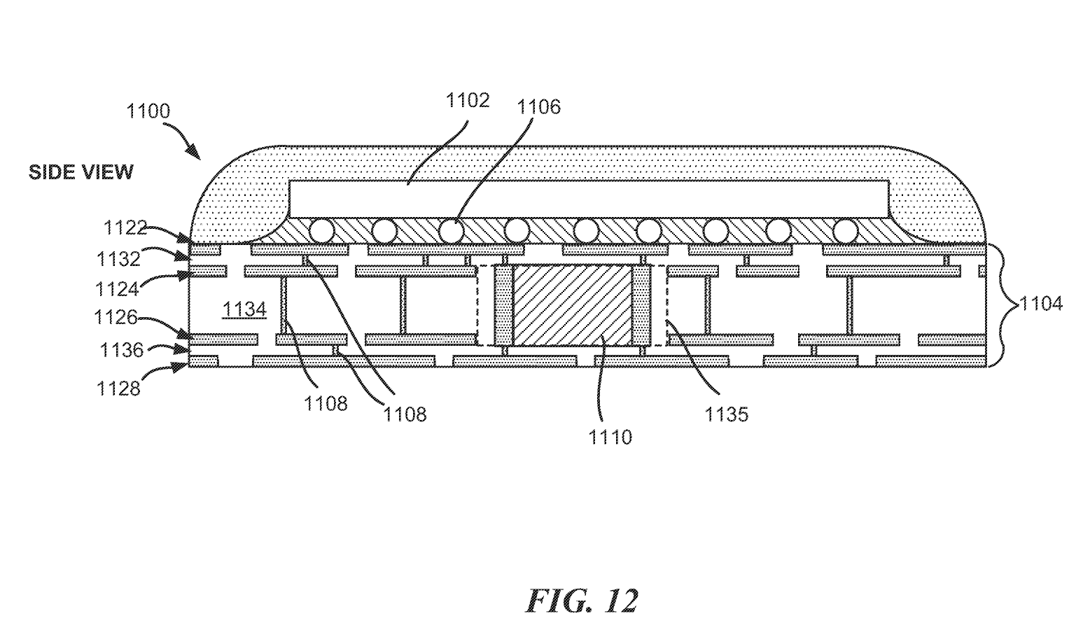

In some examples, the substrate 1002 may be part of a package-on-package (PoP) device or an encapsulated package substrate (EPS) (which is further described below with reference to FIGS. 11-12). Consequently, the thickness of the coupled inductor structures 1002-1004 is kept to the less than or equal to the thickness of die/chip 1000 (e.g., 0.2 mm or less) in some implementations.

Having described an exemplary H structure, several package substrates that include such H structures will now be described below.

Exemplary Package Substrate with Coupled Inductor Structure

In some implementations, one or more of the inductor structures (e.g., inductor structures 302, 502, 600, 700, 800) may be coupled (e.g., embedded) inside a substrate (e.g., package substrate) within a semiconductor package. FIGS. 11-12 illustrate examples of a coupled inductors structure in a substrate in some implementations. Specifically, FIG. 11 illustrates a cross-sectional, schematic view of an IC package 1100 according to one aspect of the disclosure. The IC package 1100 includes an IC die 1102 (e.g., memory circuit, processing circuit, applications processor, etc.) for an electronic device, such as, but not limited to, a mobile phone, laptop computer, tablet computer, personal computer, etc. The IC package 1100, and in particular, the IC die 1102 may be supplied power (e.g., provided nominal supply voltages and currents) from a power management integrated circuit (PMIC) (not shown) through a power delivery network (PDN) (portions of the PDN external to the IC package 1100 are not shown) associated with the electronic device.

The IC die 1102 is electrically coupled to a multi-layer package substrate 1104 below it in a flip-chip style. For example, one or more soldering balls 1106 may electrically couple the die 1102 to metal traces located within a first metal layer 1122 of the package substrate 1104. According to other aspects, the IC die 1102 may be wire bonded to the package substrate 1104. The package substrate 1104 may be, for example, a four metal layer laminate substrate. In other aspects, the package substrate 1104 may have three or more metal layers, including five, six, seven, eight, nine, or ten metal layers.

The four layer package substrate 1104 shown includes the first metal layer 1122 (e.g., first outer metal layer), a second metal layer 1124 (e.g., first inner metal layer), a third metal layer 1126 (e.g., second inner metal layer), and a fourth metal layer 1128 (e.g., second outer metal layer. Each of the metal layers 1122, 1124, 1126, 1128 are generally separated from one another by a plurality of insulating layers 1132, 1134, 1136 that may be composed of one or more dielectric materials, such as, but not limited to, epoxy and/or resin. In particular, the first insulating layer 1134 in the middle of the package substrate 1104 may be thicker than the other layers and also provides structural rigidity to the package substrate 1104. A plurality of metal vertical interconnect accesses (vias) 1108 electrically couple traces of the plurality of metal layers 1122, 1124, 1126, 1128 of the package substrate 1104 to each other where desired.

The package substrate 1104 includes a cavity 1135 (indicated by the dashed line box) that houses an embedded passive substrate (EPS) discrete circuit component (DCC) 1110, such as a capacitor, resistor, or inductor. In some implementations, the EPS discrete circuit component is the coupled inductors structure described herein (e.g., coupled inductors structure of FIGS. 2-3). It should be noted that the DCC 1110 is a conceptual representation of a DCC and does not necessarily represent exactly how the DCC (e.g., coupled inductors structure) is formed and coupled in the substrate. Rather, the DCC 1110 in FIGS. 11 and 12 is merely intended to show a possible location of a DCC in a substrate. Different implementations may use different configurations and designs to couple the electrodes of the DCC to the vias in the substrate. For example, a first electrode (which is coupled to a first conductive layer) for the DCC may be coupled to the top left vias while a second electrode (which is coupled to a second conductive layer) for the DCC may be coupled to the top right vias in some implementations.

The cavity 1135 may occupy or be located within a portion of the first insulator layer 1134, and also one or more of the inner metal layers 1124, 1126. In the illustrated example, the DCC 1110 may be, for example, a discrete capacitor (e.g., “decoupling capacitor”). According to one aspect, the discrete capacitor 1110 helps reduce the impedance at a range of frequencies of the PDN by balancing inductive components of the impedance due to the IC package 1100 (e.g., inductance caused by traces, vias, metal lines, etc. associated with the package substrate 1104). The package substrate 1104 may have a plurality of cavities each housing a separate EPS discrete circuit component.

Among other things, the package substrate 1104 may comprise one or more via coupling components (e.g., via coupling component 1140) that are electrically coupled to electrodes of the DCC 1110. The via coupling components serve as a means for increasing the available surface area to which a plurality of vias may couple to (e.g., a first end of each via may couple to the via coupling components). The via coupling components are composed of a conductive material, such as a metal or metal alloy (e.g., copper, aluminum, and/or titanium nitride, etc.). According to one aspect, the via coupling components are made of one or more of the same metals that comprise the inner metal layers 1124, 1126.

According to one aspect, a first via coupling component is electrically coupled to both a first electrode of the DCC 1110 and a first metal trace within the first inner metal layer 1124; a second via coupling component is electrically coupled to both the first electrode and a second metal trace within the second inner metal layer 1126; a third via coupling component is electrically coupled to both a second electrode of the DCC 1110 and a third metal trace within the first inner metal layer 1124; a fourth via coupling component is electrically coupled to both the second electrode and a fourth metal trace within the second inner metal layer 1126.

Each of the aforementioned metal traces may be electrically coupled to a power or ground plane associated with the package substrate 1104. For example, the first metal trace may be electrically coupled to the second metal trace by means of a via, and the third metal trace may be electrically coupled to the fourth metal trace by means of another via. In this fashion, the via coupling components may be electrically coupled to power or ground planes within the first and second inner metal layers 1124, 1126, wherein the first and second inner metal layers are closer to the first insulator layer 1134 than the outer metal layers 1122, 1128.

According to one aspect, a first portion of the first via coupling component extends beyond a first edge of the first electrode of the DCC 1110. According to another aspect, a second portion of the first via coupling component is positioned within the first inner metal layer 1124. Similarly, a first portion of the second via coupling component may extend beyond a second edge of the first electrode, and a second portion of the second via coupling component may be positioned within the second inner metal layer 1126. According to one aspect, a first portion of the third via coupling component extends beyond a first edge of the second electrode of the DCC 1110. According to another aspect, a second portion of the third via coupling component is positioned within the first inner metal layer 1124. Similarly, a first portion of the fourth via coupling component may extend beyond a second edge of the second electrode, and a second portion of the fourth via coupling component may be positioned within the second inner metal layer 1126.

FIG. 12 illustrates a capacitor structure in another substrate in some implementations. FIG. 12 is similar to FIG. 11. However, one difference between FIGS. 11 and 5 is that in FIG. 12, the substrate 1104 does not include one or more via coupling components (e.g., via coupling component 1140 of FIG. 11).

Having described various examples of coupled inductor structures, a method for operating a coupled inductor structure will now be described below.

### Exemplary Method for Providing/Manufacturing a Coupled Inductor Structure

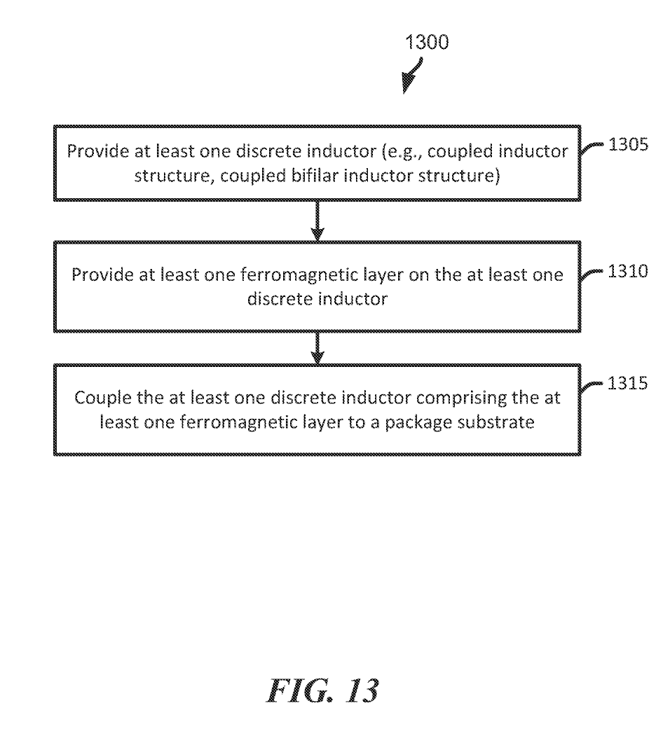

FIG. 13 illustrates a flow diagram of method for providing/manufacturing a coupled inductor structure. In some implementations, the method provides one of the coupled inductor structures described above (e.g., inductor structures 302, 502, 600, 700, 800).

The method provides (at 1305) at least one discrete inductor. In some implementations, providing the at least one discrete inductor includes provide a coupled inductor structure (e.g., inductor structures 302, 502, 600, 700, 800) that includes several discrete inductors (e.g., inductor 200). For example, the method may provide (at 1305) a coupled bifilar inductor structure (e.g., coupled bifilar inductor structure 700). Different implementations may provide different numbers of coupled inductors and/or different combinations of coupled inductors.

The method also provides (at 1310) at least one ferromagnetic layer on the least one discrete inductor. In some implementations, the at least one ferromagnetic layer is a material that has high permeability. In some implementations, a high permeability material reduces the spreading of the magnetic field, which effectively increases the inductance of the coupled inductor structure as well as minimizes interference (e.g., magnetic field interference) from adjacent electronics. Different implementations may provide the at least one ferromagnetic layer differently. Some implementations may provide a ferromagnetic layer to some of the sides of the at least one discrete inductor or coupled inductor structure.

The method further couples (at 1315) the at least one discrete inductor that includes at least one ferromagnetic layer to a package substrate. Different implementations may couple the at least one discrete inductor to a package substrate differently. In some implementations, a land side mounting is used to couple the at least one discrete inductor/coupled inductor structure to a surface of a package substrate. For example, the at least one discrete inductor/coupled inductor structure may be coupled to a package substrate of a package-on-package (PoP) configuration. In some implementations, the at least one discrete inductor/coupled inductor structure is embedded in a package substrate. FIGS. 10-12 illustrate examples of at least one discrete inductor/coupled inductor structure coupled to different locations of a package substrate.

### Exemplary Electronic Devices

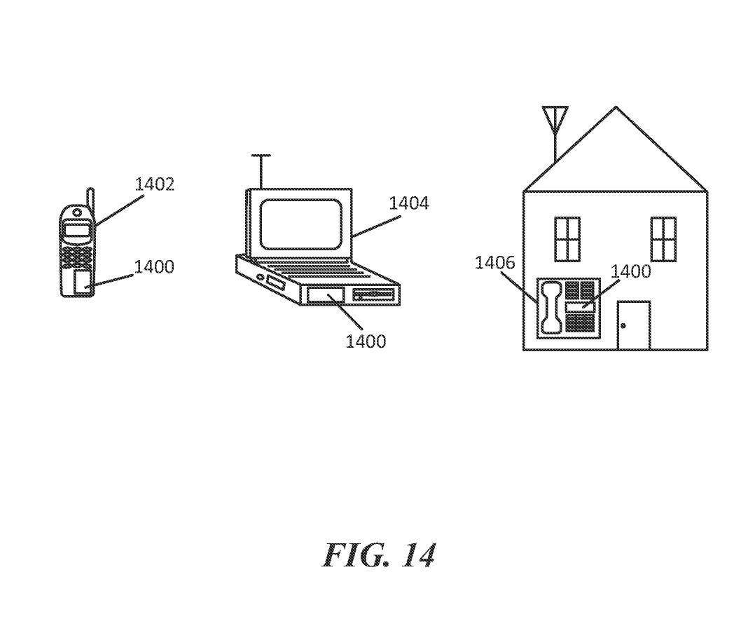

FIG. 14 illustrates various electronic devices that may be integrated with any of the aforementioned integrated circuit, die or package. For example, a mobile telephone 1402, a laptop computer 1404, and a fixed location terminal 1406 may include an integrated circuit (IC) 1400 as described herein. The IC 1400 may be, for example, any of the integrated circuits, dice or packages described herein. The devices 1402, 1404, 1406 illustrated in FIG. 14 are merely exemplary. Other electronic devices may also feature the IC 1400 including, but not limited to, mobile devices, hand-held personal communication systems (PCS) units, portable data units such as personal digital assistants, GPS enabled devices, navigation devices, set top boxes, music players, video players, entertainment units, fixed location data units such as meter reading equipment, communications devices, smartphones, tablet computers or any other device that stores or retrieves data or computer instructions, or any combination thereof.

One or more of the components, steps, features, and/or functions illustrated in FIGS. 2, 3, 4, 5, 6, 7, 8, 9, 10, 11, 12, 13 and/or 14 may be rearranged and/or combined into a single component, step, feature or function or embodied in several components, steps, or functions. Additional elements, components, steps, and/or functions may also be added without departing from the invention.

One or more of the components, steps, features and/or functions illustrated in the FIGs may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the FIGs may be configured to perform one or more of the methods, features, or steps described in the FIGs. The novel algorithms described herein may also be efficiently implemented in software and/or embedded in hardware.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The term “die package” is used to refer to an integrated circuit wafer that has been encapsulated or packaged or encapsulated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. A coupled inductor structure comprising:
a first discrete inductor configured to generate a magnetic field;
a second discrete inductor; and
a first ferromagnetic layer coupled to the first discrete inductor and the second discrete inductor, the first ferromagnetic layer configured to concentrate the magnetic field generated by the first discrete inductor within the coupled inductor structure.

2. The coupled inductor structure of claim 1, further comprising a second ferromagnetic layer coupled to the first discrete inductor and the second discrete inductor, the second ferromagnetic layer configured to concentrate the magnetic field generated by the first discrete inductor within the coupled inductor structure.

3. The coupled inductor structure of claim 1, wherein the first and second discrete inductors are co-planar.

4. The coupled inductor structure of claim 1, wherein the first discrete inductor is above the second discrete inductor.

5. The coupled inductor structure of claim 1, wherein the second discrete inductor is configured to generate a current based on the magnetic field generated by the first discrete inductor.

6. The coupled inductor structure of claim 1, wherein the coupled inductor structure is a bifilar inductor structure.

7. The coupled inductor structure of claim 6, wherein the first discrete inductor includes a first set of windings, the second discrete inductor includes a second set of windings, the first and second discrete inductors sharing a common core.

8. The coupled inductor structure of claim 1, further comprising a third discrete inductor and a fourth discrete inductor.

9. The coupled inductor structure of claim 1, wherein the first discrete inductor includes a non-metallic core and/or non-magnetic core.

10. The coupled inductor structure of claim 1, wherein the coupled inductor structure is integrated on a surface of a package substrate.

11. The coupled inductor structure of claim 10, wherein the package substrate is a substrate in a package on package (PoP) configuration.

12. The coupled inductor structure of claim 1, wherein the coupled inductor structure is integrated inside a package substrate.

13. The coupled inductor structure of claim 1, wherein the coupled inductor structure is incorporated into at least one of a music player, a video player, an entertainment unit, a navigation device, a communications device, a mobile device, a mobile phone, a smartphone, a personal digital assistant, a fixed location terminal, a tablet computer, and/or a laptop computer.

14. An apparatus comprising:
a first inductive means for generating a magnetic field;
a second inductive means; and
a first shielding means coupled to the first inductive means and the second inductive means, the first shielding means for concentrating the magnetic field generated by the first inductive means within the apparatus.

15. The apparatus of claim 14, further comprising a second shielding means coupled to the first inductive means and the second inductive means, the second shielding means for concentrating the magnetic field generated by the first inductive means within the apparatus.

16. The apparatus of claim 14, wherein the first and second inductive means are co-planar.

17. The apparatus of claim 14, wherein the first inductive means is above the second inductive means.

18. The apparatus of claim 14, wherein the second inductive means is configured to generate a current based on the magnetic field generated by the first inductive means.

19. The apparatus of claim 14, wherein the apparatus is a bifilar inductor structure.

20. The apparatus of claim 19, wherein the first inductive means includes a first set of windings, the second inductive means a second set of windings, the first and second inductive means sharing a common core.

21. The apparatus of claim 14, further comprising a third inductive means and a fourth inductive means.

22. The apparatus of claim 14, wherein the first inductive means includes a non-metallic core and/or non-magnetic core.

23. The apparatus of claim 14, wherein the apparatus is integrated on a surface of a package substrate.

24. The apparatus of claim 23, wherein the package substrate is a substrate in a package on package (PoP) configuration.

25. The apparatus of claim 14, wherein the apparatus is integrated inside a package substrate.

26. The apparatus of claim 14, wherein the apparatus is incorporated into at least one of a music player, a video player, an entertainment unit, a navigation device, a communications device, a mobile device, a mobile phone, a smartphone, a personal digital assistant, a fixed location terminal, a tablet computer, and/or a laptop computer.

27. A method for providing a coupled inductor structure, comprising:
providing a first discrete inductor configured to generate a magnetic field;
providing a second discrete inductor; and
providing a first ferromagnetic layer coupled to the first discrete inductor and the second discrete inductor, the first ferromagnetic layer configured to concentrate the magnetic field generated by the first discrete inductor within the coupled inductor structure.

28. The method of claim 27, further comprising providing a second ferromagnetic layer coupled to the first discrete inductor and the second discrete inductor, the second ferromagnetic layer configured to concentrate the magnetic field generated by the first discrete inductor within the coupled inductor structure.

29. The method of claim 27, wherein the first and second discrete inductors are co-planar.

30. The method of claim 27, wherein the first discrete inductor is provided above the second discrete inductor.

31. The method of claim 27, wherein the second discrete inductor is configured to generate a current based on the magnetic field generated by the first discrete inductor.

32. The method of claim 27, wherein the coupled inductor structure is a bifilar inductor structure.

33. The method of claim 32, wherein the first discrete inductor includes a first set of windings, the second discrete inductor includes a second set of windings, the first and second discrete inductors sharing a common core.

34. The method of claim 27, further comprising providing a third discrete inductor and a fourth discrete inductor.

35. The method of claim 27, wherein the first discrete inductor includes a non-metallic core and/or non-magnetic core.

36. The method of claim 27, further comprising integrating the coupled inductor structure on a surface of a package substrate.

37. The method of claim 36, wherein the package substrate is a substrate in a package on package (PoP) configuration.

38. The method of claim 27, further comprising integrating the coupled inductor structure inside a package substrate.

39. The method of claim 27, further incorporating the coupled inductor structure into at least one of a music player, a video player, an entertainment unit, a navigation device, a communications device, a mobile device, a mobile phone, a smartphone, a personal digital assistant, a fixed location terminal, a tablet computer, and/or a laptop computer.
